(19) United States
(12) Patent Application Publication
(10) Pub. No.: US 2025/0389561 A1
(43) Pub. Date: Dec. 25, 2025

(54) METHOD FOR CALIBRATING SENSORS IN CHILLER PLANT SYSTEM BASED ON LOGIC SELF-CONSISTENCY

(71) Applicant: Nanjing Tech University, Jiangsu (CN)

(72) Inventors: Chengchu YAN, Jiangsu (CN); Kai HU, Jiangsu (CN); Yizhe XU, Jiangsu (CN); Chaoqun ZHUANG, Jiangsu (CN)

(73) Assignee: Nanjing Tech University, Jiangsu (CN)

(21) Appl. No.: 19/230,039

(22) Filed: Jun. 5, 2025

(30) Foreign Application Priority Data
Jun. 20, 2024 (CN) 202410796392.0

(51) Int. Cl. G01D 18/00; F28F 27/00

(52) U.S. Cl. CPC G01D 18/008; F28F 27/00

(57) ABSTRACT

A method for calibrating sensors in a chiller plant system based on logic self-consistency, comprising the following steps: step 10: establishing a sensor true value logic related constraint system, and constructing a system degree of logic non-consistency calculation function, based on a sensor deployment structure in the chiller plant system; step 20: constructing a sensor correction function; step 30: collecting measurement data of sensors in the chiller plant system within a preset time period, and constructing a steady-state measurement data set; step 40: optimizing the sensor correction function based on the steady-state measurement data set, with a system degree of logic non-consistency as an optimization objective, and stopping optimization until an optimization cut-off condition is met, to obtain an optimized sensor correction function; step 50: using a correction value outputted by the optimized sensor correction function as calibrated data.

### CROSS-REFERENCE TO RELATED APPLICATION

This application claims the priority benefit of China application serial no. 202410796392.0, filed on Jun. 20, 2024. The entirety of the above-mentioned patent application is hereby incorporated by reference herein and made a part of this specification.

### BACKGROUND

### Technical Field

The present disclosure belongs to the field of sensor calibration technologies, and in particular to a method for calibrating sensors in a chiller plant system based on logic self-consistency.

### Description of Related Art

A chiller plant system needs to continuously monitor various physical measurement data (e.g., temperature, pressure, and flow), electric signal data (e.g., current and power), and operation status data (e.g., control signals and valve opening). After operation for a relatively long time, various sensors operating in complex operating conditions (e.g., high temperature, humidity, and corrosion) are affected by factors such as device aging or noise interference, and are prone to typical faults such as a complete failure, a fixed deviation, a drift deviation, and a reduction in precision, seriously affecting the data quality of a monitoring system. For example, temperature and flow sensors on a freezing system side are particularly important parameters during operation of the chiller plant system. Whether the sensors measure accurately directly affects device fault diagnosis and operation control of the chiller plant system. A key to sensor calibration is to establish accurate correspondence between a measurement and a true value (or a reference value). Currently, there are two mainstream methods: calibration by using a standard sensor; and estimation by using a mathematical model. The former uses a “zero-dimensional” single-point constraint, which is usually performed in a static test environment, ensures precision limited to a specific condition, and is not enough to comprehensively reflect accuracy of a sensor in all operating statuses. The latter depends on a “one-dimensional” equation or model constraint, the accuracy thereof strongly depends on the correctness of an input parameter, and an error of the model may also affect the reliability of the reference value. Therefore, although it seems feasible to use a method of “statically calibrating and dynamically using” the reference value or model in some scenarios, such a method may cause a significant deviation in a complex system, for example, a chiller plant system, that operates in a constantly changing internal and external environment.

### SUMMARY

The technical problem to be solved by the present disclosure is to provide a method for calibrating sensors in a chiller plant system based on logic self-consistency, which can correct measurement data of the sensors in the chiller plant system, and improve measurement precision of the sensors in the chiller plant system.

To solve the above technical problem, embodiments of the present disclosure adopt the following technical solutions:
a method for calibrating sensors in a chiller plant system based on logic self-consistency, comprising the following steps:
step 10: establishing a sensor true value logic related constraint system, and constructing a system degree of logic non-consistency calculation function, based on a sensor deployment structure in the chiller plant system;
step 20: constructing a sensor correction function;
step 30: collecting measurement data of sensors in the chiller plant system within a preset time period, and constructing a steady-state measurement data set;
step 40: optimizing the sensor correction function based on the steady-state measurement data set, with a system degree of logic non-consistency as an optimization objective, and stopping optimization until an optimization cut-off condition is met, to obtain an optimized sensor correction function; and
step 50: using a correction value outputted by the optimized sensor correction function as calibrated data.

In a preferred embodiment, the sensor true value logic related constraint system comprises a chilled water return temperature consistency related constraint relationship, a chilled water mass conservation related constraint relationship, and a chilled water energy conservation related constraint relationship.

In a preferred embodiment, the sensor true value logic related constraint system further comprises a cooling water return temperature consistency related constraint relationship, a cooling water mass conservation related constraint relationship, and a cooling water energy conservation related constraint relationship.

In a preferred embodiment, the sensor true value logic related constraint system comprises a cooling water return temperature consistency related constraint relationship, a cooling water mass conservation related constraint relationship, and a cooling water energy conservation related constraint relationship.

In a preferred embodiment, an expression of the chilled water return temperature consistency related constraint relationship is shown as formula (1):

$${T}_{chw , r 1} = … = {T}_{chw , ri} = … = {T}_{chw , rn} \qquad Formula ( 1 )$$

where T_{chw,ri} represents a chilled water return temperature of an i^{th} water chilling unit, and n represents a number of water chilling units;
an expression of the chilled water mass conservation related constraint relationship is shown as formula (2):

$${M}_{chw , 0} = {\sum }_{i = 1}^{n} {M}_{chw , i} + {M}_{chw , p} \qquad Formula ( 2 )$$

where M_{chw,0} represents a chilled water flow of a chilled water main, M_{chw,i} represents a chilled water flow of a chilled water branch where the i^{th} water chilling unit is located, and M_{chw,p} represents a chilled water flow of a chilled water bypass pipe;
an expression of the chilled water energy conservation related constraint relationship is shown as formula (3):

$$( {T}_{chw , s 0} - {T}_{chw , r 0} ) \cdot {M}_{chw , 0} = {\sum }_{i = 1}^{n} ( ( {T}_{chw , si} - {T}_{chr , ri} ) \cdot {M}_{chw , i} ) - ( \overline{{T}_{chw , s}} - \overline{{T}_{chw , r}} ) {M}_{chw , p} \qquad Formula ( 3 )$$

where T_{chw,s0} represents a chilled water temperature of a chilled water supply main, T_{chw,r0} represents a chilled water temperature of a chilled water return main, T_{chw,si} represents a chilled water supply temperature of the i^{th} water chilling unit, T̅_̅{̅c̅h̅w̅,̅s̅}̅ represents an average value of the chilled water supply temperatures of all water chilling units, and T̅_̅{̅c̅h̅w̅,̅r̅}̅ represents an average value of the chilled water return temperatures of all the water chilling units.

In a preferred embodiment, an expression of the cooling water return temperature consistency related constraint relationship is shown as formula (4):

$${T}_{cw , r 0} = {T}_{cw , r 1} = … = {T}_{cw , ri} = … = {T}_{cw , rn} \qquad Formula ( 4 )$$

where T_{cw,r0} represents a cooling water temperature of a cooling water return main, and T_{cw,ri} represents a cooling water return temperature of an i^{th} water chilling unit;
an expression of the cooling water mass conservation related constraint relationship is shown as formula (5):

$${M}_{cw , 0} = {\sum }_{i = 1}^{n} {M}_{cw , n} + {M}_{cw , p} \qquad Formula ( 5 )$$

where M_{cw,0} represents a cooling water flow of a cooling water main, M_{cw,i} represents a cooling water flow of a cooling water branch where the i^{th} water chilling unit is located, and M_{cw,p} represents a cooling water flow of a cooling water bypass pipe;
an expression of the cooling water energy conservation related constraint relationship is shown as formula (6):

$$( {T}_{cw , s 0} - {T}_{cw , r 0} ) \cdot {M}_{cw , 0} = {\sum }_{i = 1}^{n} ( ( {T}_{cw , si} - {T}_{cw , ri} ) \cdot {M}_{cw , i} ) - ( \overline{{T}_{cw , s}} - \overline{{T}_{cw , r}} ) {M}_{cw , p} \qquad Formula ( 6 )$$

where T_{cw,s0} represents a cooling water temperature of a cooling water supply main, T_{cw,r0} represents the cooling water temperature of a cooling water return main, T_{cw,si} represents a cooling water supply temperature of the i^{th} water chilling unit, T̅_̅{̅c̅w̅,̅s̅}̅ represents an average value of the cooling water supply temperature of all water chilling units, and T̅_̅{̅c̅w̅,̅r̅}̅ represents an average value of the cooling water return temperature of all the water chilling units.

In a preferred embodiment, an expression of the system degree of logic non-consistency calculation function is shown as formula (7):

$$D ( LN ) = {\sum }_{e = 1}^{E} {ω}_{e} \frac{\vert {Y}_{L , e} - {Y}_{R , e} \vert}{\vert {Y}_{L , e , max} - {Y}_{R , e , min} \vert} \qquad Formula ( 7 )$$

where D(LN) represents an value of the system degree of logic non-consistency; ωₑ represents a weight coefficient of an e^{th} related constraint relationship; E represents a total number of related constraint relationships in the sensor true value logic related constraint system; Y_{L,e} represents a calculated value on a left side of an expression of the e^{th} related constraint relationship calculated based on a sensor correction value; Y_{R,e} represents an calculated value on a right side of an expression of the e^{th} related constraint relationship calculated based on the sensor correction value; Y_{L,e,max} represents a maximum value in calculated values on the left side of the expression of the e^{th} related constraint relationship calculated based on sensor correction values at all moments; and Y_{R,e,min} represents a minimum value in calculated values on the right side of the expression of the e^{th} related constraint relationship calculated based on the sensor correction values at all moments.

In a preferred embodiment, an expression of the sensor correction function is shown as formula (8):

$$Y = aX + b \qquad Formula ( 8 )$$

where Y represents a sensor correction value, a represents a linear deviation calibration factor, X represents a sensor measurement, and b represents a fixed deviation calibration factor.

In a preferred embodiment, step 30 specifically comprises:
step 301: collecting measurement data of the sensors in the chiller plant system within a preset time period, and performing time-division preprocessing on the measurement data of each sensor by a rolling time window;
step 302: calculating a data coefficient of variation of each sensor in each time period by formula (9):

$$CV = \frac{σ}{μ} \qquad Formula ( 9 )$$

where CV represents the data coefficient of variation, σ represents a data standard deviation, and μ represents an average value; and

step 303: selecting measurement data in a time period when the data coefficients of variation of all the sensors are less than a coefficient threshold, to form steady-state measurement data.

In a preferred embodiment, in step 50, the sensor correction function is iteratively optimized by a gradient descent method or a genetic algorithm, to obtain an optimized sensor correction function.

Compared with the prior art, the technical solutions of the present disclosure have the following beneficial effects:

According to the method for calibrating sensors in a chiller plant system based on logic self-consistency provided by the embodiments of the present disclosure, a sensor true value logic related constraint system is established, and a system degree of logic non-consistency calculation function is constructed, based on a sensor deployment structure in the chiller plant system. Next, a sensor correction function is constructed. Then, measurements of sensors in the chiller plant system are collected within a preset time period, and a steady-state measurement data set is constructed. Finally, the sensor correction function is optimized based on the steady-state measurement data set, with the system degree of logic non-consistency as an optimization objective, and optimization is stopped until an optimization cut-off condition is met, to obtain an optimized sensor correction function. A correction value outputted by the optimized sensor correction function is used as calibrated data. According to the method in the embodiments of the present disclosure, data correlation between measurements and calibration values of all sensors is implemented by constructing the sensor correction function, an value of a system degree of logic non-consistency calculation function is constructed, correction parameters of the sensor correction function are optimized with an objective that the system degree of logic non-consistency is the minimum, intermediate correction values of all sensors are obtained until the intermediate correction values satisfy the sensor true value logic related constraint system to the greatest extent, and the most suitable correction parameter is determined, that is, the most suitable sensor correction function is obtained, thereby correcting the sensor measurement data in the chiller plant system, obtaining calibrated data close to true values to the greatest extent, and improving measurement precision of the sensors in the chiller plant system.

### BRIEF DESCRIPTION OF THE DRAWINGS

In order to more clearly illustrate the technical solutions of the embodiments of the present disclosure, the accompanying drawings required in the embodiments of the present disclosure will be briefly introduced below. Apparently, the accompanying drawings in the following description show merely some embodiments of the present disclosure, and those of ordinary skill in the art may also obtain other accompanying drawings according to these accompanying drawings without creative efforts.

FIG. 1 is a flowchart of a method according to an embodiment of the present disclosure; and

FIG. 2 is a schematic diagram of a sensor deployment structure in a chiller plant system in a method according to an embodiment of the present disclosure.

### DESCRIPTION OF THE EMBODIMENTS

The technical solutions of the present disclosure are described in detail below with reference to the accompanying drawings.

Sensor calibration relates to comparing a sensor measurement with a “true value” (a reference value), to determine and correct an error, so that outputted data satisfies a measurement requirement. During normal operation of a chiller plant system, a true value and a measurement of a sensor constantly change, and have an uncertain deviation relationship in between, including drift errors, fixed errors, random errors, and the like. Currently, research on calibration of a small number of sensors having fixed deviations is relatively sufficient. However, in an actual measurement scenario, there are many types and a large number of sensors with uncertain types and degrees of deviations, which constitutes a big real challenge to automatic calibration of sensors.

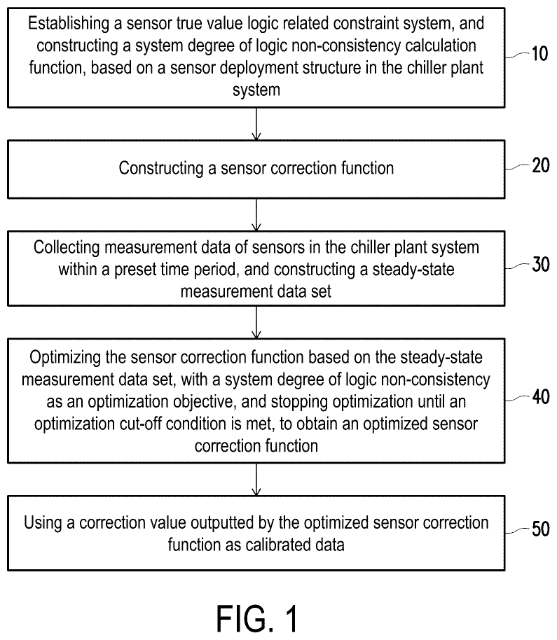

Therefore, an embodiment of the present disclosure provides a method for calibrating sensors in a chiller plant system based on logic self-consistency. As shown in FIG. 1, the method includes the following steps:

Step 10: A sensor true value logic related constraint system is established, and a system degree of logic non-consistency calculation function is constructed, based on a sensor deployment structure in a chiller plant system.

Step 20: A sensor correction function is constructed.

Step 30: Measurement data of sensors in the chiller plant system are collected within a preset time period, and a steady-state measurement data set is constructed.

Step 40: The sensor correction function is optimized based on the steady-state measurement data set, with a system degree of logic non-consistency as an optimization objective, and optimization is stopped until an optimization cut-off condition is met, to obtain an optimized sensor correction function.

Step 50: A correction value outputted by the optimized sensor correction function is used as calibrated data.

The working condition in the chiller plant system constantly changes with time, and the error characteristics of the sensors are certain. According to the method in the embodiments of the present disclosure, data correlation between measurements and correction values of all sensors is implemented by constructing the sensor correction function, a system degree of logic non-consistency calculation function is constructed, correction parameters of the sensor correction function are optimized with an objective that an value of the system degree of logic non-consistency is the minimum, intermediate correction values of all sensors are obtained until the intermediate correction values satisfy the sensor true value logic related constraint system to the greatest extent, and the most suitable correction parameter is determined, that is, the most suitable sensor correction function is obtained, thereby calibrating the sensor measurement data in the chiller plant system, obtaining calibrated data close to true values to the greatest extent, and improving measurement precision of the sensors in the chiller plant system.

As shown in FIG. 1, a sensor deployment structure in a chiller plant system is as follows: In a chilled water system, a chilled water main includes a chilled water return main and a chilled water supply main. Chilled water branches, the number of which is the same as that of water chilling units, are arranged between the chilled water return main and the chilled water supply main. Evaporators of the water chilling units are arranged on the chilled water branches. Sections of the chilled water branches connected to the chilled water return main are chilled water return branches, and sections of the chilled water branches connected to the chilled water supply main are chilled water supply branches. Temperature sensors and flow sensors are arranged on both the chilled water return main and the chilled water return branches. Temperature sensors and flow sensors are arranged on both the chilled water supply branches and the chilled water supply main. Chilled water bypass pipes are arranged between the chilled water supply main and the chilled water return main, and have a flow direction from the chilled water supply main to the chilled water return main. Flow sensors are arranged on the chilled water bypass pipes.

In a cooling water system, a cooling water main includes a cooling water return main and a cooling water supply main. Cooling water branches, the number of which is the same as that of the water chilling units, are arranged between the cooling water return main and the cooling water supply main. Condensers of the water chilling units are arranged on the cooling water branches. Sections of the cooling water branches connected to the cooling water return main are cooling water return branches, and sections of the cooling water branches connected to the cooling water supply main are cooling water supply branches. Temperature sensors and flow sensors are arranged on both the cooling water return main and the cooling water return branches. Temperature sensors and flow sensors are arranged on both the cooling water supply branches and the cooling water supply main. Cooling water bypass pipes are arranged between the cooling water supply main and the cooling water return main, and have a flow direction from the cooling water return main to the cooling water supply main. Flow sensors are arranged on the cooling water bypass pipes.

In step 10, in the chilled water system of the chiller plant system, because chilled water in the chilled water branches where the water chilling units are located comes from the same thoroughly mixed chilled water return main, theoretically, when the sensors have no error, the chilled water return temperatures of all the water chilling units started at the same time should be equal. A chilled water return temperature consistency related constraint relationship as shown in formula (1) is established:

$${T}_{chw , r 1} = … = {T}_{chw , ri} = … = {T}_{chw , rn} \qquad Formula ( 1 )$$

where T_{chw,ri} represents a chilled water return temperature of an i^{th} water chilling unit, and n represents a number of the water chilling units.

Without leakage, the sum of the flow of chilled water flowing through every chilled water branch and the flow of chilled water flowing through the chilled water bypass pipes should match the flow in the chilled water main, that is, the sum of the flow of all the chilled water branches and the flow of the chilled water bypass pipes should be equal to the flow of the chilled water main. A chilled water mass conservation related constraint relationship as shown in formula (2) is established:

$${M}_{chw , 0} = {\sum }_{i = 1}^{n} {M}_{chw , i} + {M}_{chw , p} \qquad Formula ( 2 )$$

where M_{chw,0} represents a chilled water flow of the chilled water main, M_{chw,i} represents a chilled water flow of the chilled water branch where the i^{th} water chilling unit is located, and M_{chw,p} represents a chilled water flow of the chilled water bypass pipe.

The chilled water from every water chilling unit, mixed in the chilled water main, should satisfy an energy balance law:

$${Q}_{chw , 0} = {\sum }_{i = 1}^{n} {Q}_{chw , i} + {Q}_{chw , p}$$

where Q_{chw,0} represents the cooling load of the chilled water main, Q_{chw,i} represents the cooling load of the i^{th} chilled water branch, and Q_{chw,p} represents the cooling load of the chilled water bypass pipe.

Because the chilled water return temperatures of the water chilling units are consistent and the flow meets mass conservation, a chilled water energy conservation related constraint relationship shown as formula (3) is established:

$$( {T}_{chw , s 0} - {T}_{chw , r 0} ) \cdot {M}_{chw , 0} = {\sum }_{i = 1}^{n} ( ( {T}_{chw , si} - {T}_{chw , ri} ) \cdot {M}_{chw , i} ) - ( \overline{{T}_{chw , s}} - \overline{{T}_{chw , r}} ) {M}_{chw , p} \qquad Formula ( 3 )$$

where T_{chw,s0} represents a chilled water temperature of a chilled water supply main, T_{chw,r0} represents a chilled water temperature of a chilled water return main, T_{chw,si} represents a chilled water supply temperature of the i^{th} water chilling unit, T̅_̅{̅c̅h̅w̅,̅s̅}̅ represents an average value of the chilled water supply temperatures of all water chilling units, and T̅_̅{̅c̅h̅w̅,̅r̅}̅ represents an average value of the chilled water return temperatures of all the water chilling units.

In the cooling water system of the chiller plant system, because cooling water in the cooling water branches where the water chilling units are located comes from the same thoroughly mixed cooling water return main, theoretically, when the sensors have no error, the cooling water return temperatures of all the water chilling units started at the same time should be equal, and is also equal to the cooling water return temperature of the cooling water return main. A cooling water return temperature consistency related constraint relationship as shown in formula (4) is established:

$${T}_{cw , r 0} = {T}_{cw , r 1} = … = {T}_{cw , ri} = … = {T}_{cw , rn} \qquad Formula ( 4 )$$

where T_{cw,r0} represents a cooling water temperature of the cooling water return main, and T_{cw,ri} represents a cooling water return temperature of an i^{th} water chilling unit.

Without leakage, the sum of the flow of cooling water flowing through every cooling water branch and the flow of cooling water flowing through the cooling water bypass pipes should match the flow in the cooling water main, that is, the sum of the flow of all the cooling water branches and the flow of the cooling water bypass pipes should be equal to the flow of the cooling water main. A cooling water mass conservation related constraint relationship as shown in formula (5) is established:

$${M}_{cw , 0} = {\sum }_{i = 1}^{n} {M}_{cw , i} + {M}_{cw , p} \qquad Formula ( 5 )$$

where M_{cw,0} represents a cooling water flow of the cooling water main, M_{cw,i} represents a cooling water flow of the cooling water branch where the i^{th} water chilling unit is located, and M_{cw,p} represents a cooling water flow of the cooling water bypass pipe.

The cooling water from every water chilling unit, mixed in the cooling water main, should satisfy an energy balance law:

$${Q}_{cw , 0} = {\sum }_{i = 1}^{n} {Q}_{cw , i} + {Q}_{cw , p}$$

where Q_{cw,0} represents the cooling load of the cooling water main, Q_{cw,i} represents the cooling load of the cooling water branch where the i^{th} water chilling unit is located, and Q_{cw,p} represents the cooling load of the cooling water bypass pipe.

Because the chilled water return temperatures of the water chilling units are consistent and the flow meets mass conservation, a cooling water energy conservation related constraint relationship shown as formula (6) is established:

$$( {T}_{cw , s 0} - {T}_{cw , r 0} ) \cdot {M}_{cw , 0} = {\sum }_{i = 1}^{n} ( ( {T}_{cw , si} - {T}_{cw , ri} ) \cdot {M}_{cw , i} ) - ( \overline{{T}_{cw , s}} - \overline{{T}_{cw , r}} ) {M}_{cw , p} \qquad Formula ( 6 )$$

where T_{cw,s0} represents a cooling water temperature of a cooling water supply main, T_{cw,r0} represents the cooling water temperature of a cooling water return main, T_{cw,si} represents a cooling water supply temperature of the i^{th} water chilling unit, T̅_̅{̅c̅w̅,̅s̅}̅ represents an average value of the cooling water supply temperature of all water chilling units, and T̅_̅{̅c̅w̅,̅r̅}̅ represents an average value of the cooling water return temperature of all the water chilling units.

If only the temperature sensors and flow sensors in the chilled water system are calibrated, the chilled water return temperature consistency related constraint relationship, the chilled water mass conservation related constraint relationship, and the chilled water energy conservation related constraint relationship constitute the sensor true value logic related constraint system.

If only the temperature sensors and flow sensors in the cooling water system are calibrated, the cooling water return temperature consistency related constraint relationship, the cooling water mass conservation related constraint relationship, and the cooling water energy conservation related constraint relationship constitute a multi-dimensional sensor true value logic related constraint relationship.

If the temperature sensors and flow sensors on both the chilled water system side and the cooling water system side are calibrated, the chilled water return temperature consistency related constraint relationship, the chilled water mass conservation related constraint relationship, the chilled water energy conservation related constraint relationship, the cooling water return temperature consistency related constraint relationship, the cooling water mass conservation related constraint relationship, and the cooling water energy conservation related constraint relationship constitute a multi-dimensional sensor true value logic related constraint relationship.

A system degree of logic non-consistency calculation function is constructed. Specifically, in the sensor true value logic related constraint system, a degree of non-consistency of a related constraint relationship refers to a relative deviation of unequal values on left and right sides caused by substituting a correction value into the related constraint relational expression, which is shown as follows:

$${\underbrace{f ( {x}_{l , 1} , {x}_{l , 2} , … , {x}_{l , a} )}}_{{Y}_{L}} = {\underbrace{g ( {x}_{l , 1} , {x}_{l , 2} , … , {x}_{l , b} )}}_{{Y}_{R}}$$

$$D ( {LN}_{e} ) = \frac{\vert {Y}_{L} - {Y}_{R} \vert}{max ( {Y}_{L} , {Y}_{R} )}$$

where x_{l,1}, x_{l,2}, . . . , x_{l,a} represents a sensor correction value on the left side of the related constraint relational expression, x_{l,1}, x_{l,2}, . . . , x_{l,b} represents a sensor correction value on the right side of the related constraint relational expression, Y_{L} represents the calculated value on the left side of the related constraint relational expression, Y_{R} represents the calculated value on the right side of the related constraint relational expression, and D(LNₑ) represents the degree of logic non-consistency of the e^{th} related constraint relationship.

The degrees of non-consistency of all the related constraint relationships are weighted to obtain the total degree of non-consistency of the entire chiller plant system, that is, an expression of the system degree of logic non-consistency calculation function is shown as formula (7):

$$D ( LN ) = {\sum }_{e = 1}^{E} {ω}_{e} \frac{\vert {Y}_{L , e} - {Y}_{R , e} \vert}{\vert {Y}_{L , e , max} - {Y}_{R , e , min} \vert} \qquad Formula ( 7 )$$

where D(LN) represents an value of the system degree of logic non-consistency; ωₑ represents a weight coefficient of an e^{th} related constraint relationship; E represents a total number of related constraint relationships in the sensor true value logic related constraint system; Y_{L},e represents a calculated value on the left side of the expression of the e^{th} related constraint relationship calculated based on a sensor correction value; Y_{R,e} represents a calculated value on the right side of the expression of the e^{th} related constraint relationship calculated based on the sensor correction value; Y_{L,e,max} represents a maximum value in calculated values on the left side of the expression of the e^{th} related constraint relationship calculated based on sensor calibration values at all moments; and Y_{R,e,min} represents a minimum value in calculated values on the right side of the expression of the e^{th} related constraint relationship calculated based on the sensor correction values at all moments.

In step 20, the sensor correction function is established to compensate for the linear drift deviation and the fixed deviation in sensor measurement, as shown in formula (8):

$$Y = aX + b \qquad Formula ( 8 )$$

where Y represents a sensor correction value, a represents a linear deviation calibration factor, X represents a sensor measurement, and b represents a fixed deviation calibration factor.

In the method of this embodiment, the measurements of all the sensors to be calibrated are integrated into a measurement matrix, the linear deviation calibration factors of all the sensors to be calibrated are integrated into a linear deviation calibration matrix, and the fixed deviation calibration factors of all the sensors to be calibrated are integrated into a fixed deviation calibration matrix, to obtain a correction value matrix of all the sensors to be calibrated.

Preferably, step 30 specifically includes:

Step 301: Measurement data of the sensors in the chiller plant system are collected within a preset time period, and time-division preprocessing is performed on the measurement data of each sensor by a rolling time window. Preferably, the time period of the rolling time window is 30 min.

Step 302: A data coefficient of variation of each sensor in each time period is calculated by formula (9):

$$CV = \frac{σ}{μ} \qquad Formula ( 9 )$$

where CV represents the data coefficient of variation, σ represents a data standard deviation, and μ represents an average value.

Step 303: Measurement data in a time period when the data coefficients of variation of all the sensors are less than a coefficient threshold are selected, to form a steady-state measurement data set. That is, the measurements of all the sensors within the time period are added to the steady-state measurement data set only when the data coefficients of variation of the measurements of all the sensors within the same time period are less than the coefficient threshold. The coefficient threshold is set based on system experience and expected stability. Preferably, the coefficient threshold is 0.1.

In the above embodiment, the coefficient of variation is used as an index for measuring fluctuations of the measurement data, and the measurement data having the coefficients of variation are less than the coefficient threshold forms the steady-state measurement data set. The measurement data in the steady-state measurement data set has small fluctuations, indicating that the system reaches balance and keeps unchanged, that is, a steady-state working condition, without external disturbance such as load change and ambient temperature change. Measurement parameters of the system in the steady-state working condition satisfy a physical law. The steady-state measurement data set reflects the real performance of the system in an unperturbed status, and includes data that is more representative, thereby improving the accuracy of true value determination.

In step 40, a correction coefficient matrix is continuously iteratively optimized based on the steady-state measurement data set, with the system degree of logic non-consistency as an optimization objective, by using a suitable machine learning optimization algorithm (e.g., a gradient descent method or a genetic algorithm), until the system degree of logic non-consistency is minimized. In this case, a correction value of a sensor is closest to a true value of the sensor. A correction value outputted by the optimized sensor correction function is used as calibrated data.

A specific example is provided below.

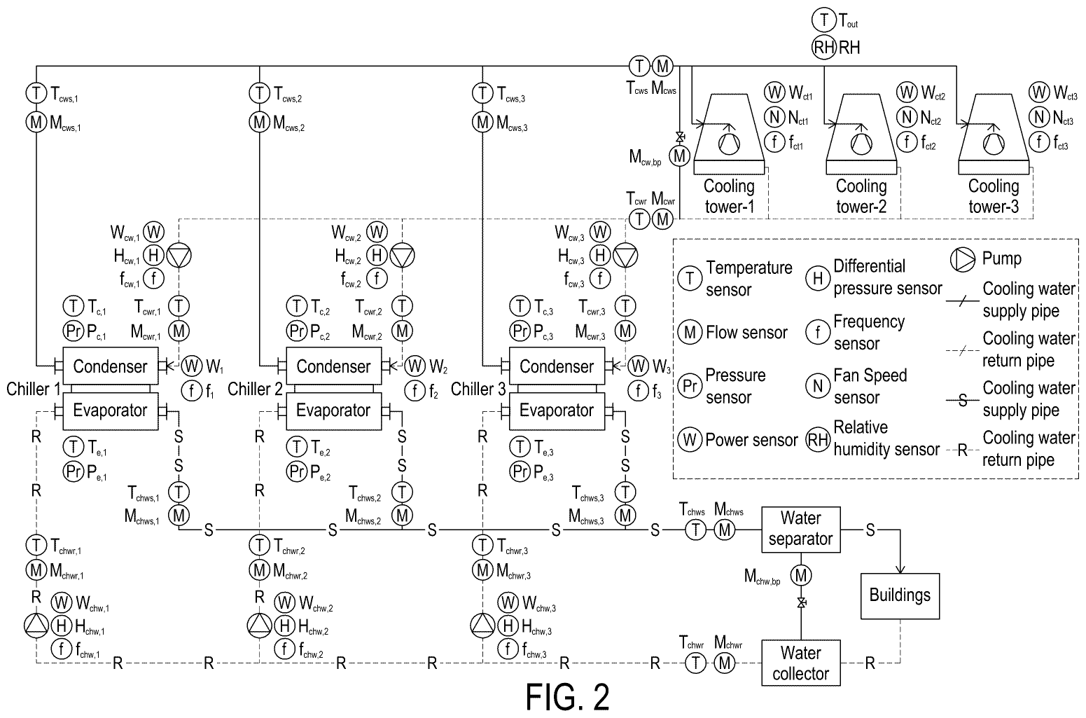

A chiller plant system shown in FIG. 2 includes 3 water chilling units. Temperature sensors and flow sensors are arranged on a chilled water return main and 3 chilled water return branches, and temperature sensors are arranged on a chilled water supply main and 3 chilled water supply branches. In this embodiment, fault-free analog data of the temperature sensors and the flow sensors in the chilled water system shown in FIG. 2 is used. Errors (a fixed deviation and a linear deviation) are set based on the fault-free analog data. The analog data with the errors set is calibrated by the method of the present disclosure. The calibrated analog data is compared with the fault-free analog data. The results of error recovery are shown in Table 1.

TABLE 1
Error setting and calibration results

| | T_{chws, 1} | T_{chwr, 1} | T_{cwr, 1} | M_{chw, 1} | T_{chws, 2} | M_{chw, 2} | T_{chws, 3} | M_{chw, 3} |
|---|---|---|---|---|---|---|---|---|
| | (° C.) | (° C.) | (° C.) | (t/h) | (° C.) | (t/h) | (° C.) | (t/h) |
| Error | 0.8 | −1.5 | 2.0 | 45 | 0.9 | *1.2 | −0.7 | *0.8 |
| Calibration | 0.75 | −1.44 | 1.94 | 48 | 1 | 1.19 | −0.57 | 0.89 |
| result | | | | | | | | |
| Calibration | 94% | 96% | 97% | 93% | 89% | 99% | 81% | 88% |
| precision | | | | | | | | |

From Table 1, the method of the present disclosure can relatively well identify the fixed deviation and the linear deviation of the sensor, and calibrate detection data of the sensor. The average calibration precision is greater than 90%, and the calibration effect is relatively good.

The basic principle, main features, and advantages of the present disclosure are illustrated and described above. Those skilled in the art should understand that the present disclosure is not limited by the above specific embodiments, and the above specific embodiments and the description in this specification only further explain the principle of the present disclosure. Without departing from the spirit and scope of the present disclosure, the present disclosure may also undergo various changes and improvements, and these changes and improvements fall within the scope set forth in the present disclosure.

What is claimed is:

1. A method for calibrating sensors in a chiller plant system based on logic self-consistency, comprising the following steps:
step 10: establishing a sensor true value logic related constraint system, and constructing a system degree of logic non-consistency calculation function, based on a sensor deployment structure in the chiller plant system;
step 20: constructing a sensor correction function;
step 30: collecting measurement data of sensors in the chiller plant system within a preset time period, and constructing a steady-state measurement data set;
step 40: optimizing the sensor correction function based on the steady-state measurement data set, with a system degree of logic non-consistency as an optimization objective, and stopping optimization until an optimization cut-off condition is met, to obtain an optimized sensor correction function; and
step 50: using a correction value outputted by the optimized sensor correction function as calibrated data.

2. The method for the calibrating sensors in the chiller plant system based on logic self-consistency according to claim 1, wherein the sensor true value logic related constraint system comprises a chilled water return temperature consistency related constraint relationship, a chilled water mass conservation related constraint relationship, and a chilled water energy conservation related constraint relationship.

3. The method for the calibrating sensors in the chiller plant system based on logic self-consistency according to claim 2, wherein the sensor true value logic related constraint system further comprises a cooling water return temperature consistency related constraint relationship, a cooling water mass conservation related constraint relationship, and a cooling water energy conservation related constraint relationship.

4. The method for the calibrating sensors in the chiller plant system based on logic self-consistency according to claim 1, wherein the sensor true value logic related constraint system comprises a cooling water return temperature consistency related constraint relationship, a cooling water mass conservation related constraint relationship, and a cooling water energy conservation related constraint relationship.

5. The method for the calibrating sensors in the chiller plant system based on logic self-consistency according to claim 2, wherein an expression of the chilled water return temperature consistency related constraint relationship is shown as formula (1):
$${T}_{c h w , r 1} = … = {T}_{c h w , r i} = … = {T}_{c h w , r n} \qquad Formula ( 1 )$$
where T_{chw,ri} represents a chilled water return temperature of an i^{th} water chilling unit, and n represents a number of water chilling units;
an expression of the chilled water mass conservation related constraint relationship is shown as formula (2):
$${M}_{c h w , 0} = {\sum }_{i = 1}^{n} {M}_{c h w , i} + {M}_{c h w , p} \qquad Formula ( 2 )$$
where M_{chw,0} represents a chilled water flow of a chilled water main, M_{chw,i} represents a chilled water flow of a chilled water branch where the i^{th} water chilling unit is located, and M_{chw,p} represents a chilled water flow of a chilled water bypass pipe;
an expression of the chilled water energy conservation related constraint relationship is shown as formula (3):
$$( {T}_{chw , s0} - {T}_{chw , r0} ) \cdot {M}_{c h w , 0} = {\sum }_{i = 1}^{n} ( ( {T}_{chw , si} - {T}_{chw , ri} ) \cdot {M}_{chw , i} ) - ( \overline{{T}_{chw , s}} - \overline{{T}_{chw , r}} ) {M}_{chw , p} \qquad Formula ( 3 )$$
where T_{chw,s0} represents a chilled water temperature of a chilled water supply main, T_{chw,r0} represents a chilled water temperature of a chilled water return main, T_{chw,si} represents a chilled water supply temperature of the i^{th} water chilling unit, T̅_̅{̅c̅h̅w̅,̅s̅}̅ represents an average value of chilled water supply temperatures of all water chilling units, and T̅_̅{̅c̅h̅w̅,̅r̅}̅ represents an average value of the chilled water return temperatures of all the water chilling units.

6. The method for the calibrating sensors in the chiller plant system based on logic self-consistency according to claim 3, wherein an expression of the cooling water return temperature consistency related constraint relationship is shown as formula (4):
$${T}_{c w , r 0} = {T}_{c w , r 1} = … = {T}_{c w , r i} = … = {T}_{c w , r n} \qquad Formula ( 4 )$$
where T_{cw,r0} represents a cooling water temperature of a cooling water return main, and T_{cw,ri} represents a cooling water return temperature of an i^{th} water chilling unit;
an expression of the cooling water mass conservation related constraint relationship is shown as formula (5):
$${M}_{c w , 0} = {\sum }_{i = 1}^{n} {M}_{c w , i} + {M}_{c w , p} \qquad Formula ( 5 )$$
where M_{cw,0} represents a cooling water flow of a cooling water main, M_{cw,i} represents a cooling water flow of a cooling water branch where the i^{th} water chilling unit is located, and M_{cw,p} represents a cooling water flow of a cooling water bypass pipe;
an expression of the cooling water energy conservation related constraint relationship is shown as formula (6):
$$( {T}_{cw , s 0} - {T}_{cw , r 0} ) \cdot {M}_{cw , 0} = {\sum }_{i = 1}^{n} ( ( {T}_{cw , si} - {T}_{cw , ri} ) \cdot {M}_{cw , i} ) - ( \overline{{T}_{cw , s}} - \overline{{T}_{cw , r}} ) {M}_{cw , p} \qquad Formula ( 6 )$$
where T_{cw,s0} represents a cooling water temperature of a cooling water supply main, T_{cw,r0} represents the cooling water temperature of the cooling water return main, T_{cw,si} represents a cooling water supply temperature of the i^{th} water chilling unit, T̅_̅{̅c̅w̅,̅s̅}̅ represents an average value of the cooling water supply temperature of all water chilling units, and T̅_̅{̅c̅w̅,̅r̅}̅ represents an average value of the cooling water return temperature of all the water chilling units.

7. The method for the calibrating sensors in the chiller plant system based on logic self-consistency according to claim 1, wherein an expression of the system degree of logic non-consistency calculation function is shown as formula (7):
$$D ( L N ) = {\sum }_{e = 1}^{E} {ω}_{e} \frac{\vert {Y}_{L , e} - {Y}_{R e} \vert}{\vert {Y}_{L , e , max} - {Y}_{R , e , min} \vert} \qquad Formula ( 7 )$$
where D(LN) represents an value of the system degree of logic non-consistency; ωₑ represents a weight coefficient of an e^{th} related constraint relationship; E represents a total number of related constraint relationships in the sensor true value logic related constraint system; Y_{L,e} represents a calculated value on a left side of an expression of the e^{th} related constraint relationship calculated based on a sensor correction value; Y_{R,e} represents an calculated value on a right side of an expression of the e^{th} related constraint relationship calculated based on the sensor correction value; Y_{L,e,max} represents a maximum value in calculated values on the left side of the expression of the e^{th} related constraint relationship calculated based on sensor correction values at all moments; and Y_{R,e,min} represents a minimum value in calculated values on the right side of the expression of the e^{th} related constraint relationship calculated based on the sensor correction values at all moments.

8. The method for the calibrating sensors in the chiller plant system based on logic self-consistency according to claim 1, wherein an expression of the sensor correction function is shown as formula (8):
$$Y = aX + b \qquad Formula ( 8 )$$
where Y represents the sensor correction value, a represents a linear deviation calibration factor, X represents a sensor measurement, and b represents a fixed deviation calibration factor.

9. The method for the calibrating sensors in the chiller plant system based on logic self-consistency according to claim 1, wherein the step 30 specifically comprises:
step 301: collecting the measurement data of the sensors in the chiller plant system within a preset time period, and performing time-division preprocessing on the measurement data of each of sensors by a rolling time window;
step 302: calculating a data coefficient of variation of each of sensors in each of time periods by formula (9):
$$C V = \frac{σ}{μ} \qquad Formula ( 9 )$$
where CV represents the data coefficient of variation, σ represents a data standard deviation, and μ represents an average value; and
step 303: selecting the measurement data in a time period when the data coefficients of variation of all the sensors are less than a coefficient threshold, to form steady-state measurement data.

10. The method for the calibrating sensors in the chiller plant system based on logic self-consistency according to claim 1, wherein in the step 50, the sensor correction function is iteratively optimized by one of a gradient descent method and a genetic algorithm, to obtain the optimized sensor correction function.

11. The method for the calibrating sensors in the chiller plant system based on logic self-consistency according to claim 3, wherein an expression of the chilled water return temperature consistency related constraint relationship is shown as formula (1):
$${T}_{c h w , r 1} = … = {T}_{c h w , r i} = … = {T}_{c h w , r n} \qquad Formula ( 1 )$$
where T_{chw,ri} represents a chilled water return temperature of an i^{th} water chilling unit, and n represents a number of water chilling units;
an expression of the chilled water mass conservation related constraint relationship is shown as formula (2):
$${M}_{c h w , 0} = {\sum }_{i = 1}^{n} {M}_{c h w , i} + {M}_{c h w , p} \qquad Formula ( 2 )$$
where M_{chw,0} represents a chilled water flow of a chilled water main, M_{chw,i} represents a chilled water flow of a chilled water branch where the i^{th} water chilling unit is located, and M_{chw,p} represents a chilled water flow of a chilled water bypass pipe;
an expression of the chilled water energy conservation related constraint relationship is shown as formula (3):
$$( {T}_{chw , s 0} - {T}_{chw , r 0} ) \cdot {M}_{c h w , 0} = {\sum }_{i = 1}^{n} ( ( {T}_{chw , si} - {T}_{chw , ri} ) \cdot {M}_{chw , i} ) - ( \overline{{T}_{chw , s}} - \overline{{T}_{chw , r}} ) {M}_{chw , p} \qquad Formula ( 3 )$$
where T_{chw,s0} represents a chilled water temperature of a chilled water supply main, T_{chw,r0} represents a chilled water temperature of a chilled water return main, T_{chw,si} represents a chilled water supply temperature of the i^{th} water chilling unit, T̅_̅{̅c̅h̅w̅,̅s̅}̅ represents an average value of chilled water supply temperatures of all water chilling units, and T̅_̅{̅c̅h̅w̅,̅r̅}̅ represents an average value of the chilled water return temperatures of all the water chilling units.

12. The method for the calibrating sensors in the chiller plant system based on logic self-consistency according to claim 4, wherein an expression of the cooling water return temperature consistency related constraint relationship is shown as formula (4):
$${T}_{c w , r 0} = {T}_{c w , r 1} = … = {T}_{c w , r i} = … = {T}_{c w , r n} \qquad Formula ( 4 )$$
where T_{cw,r0} represents a cooling water temperature of a cooling water return main, and T_{cw,ri} represents a cooling water return temperature of an i^{th} water chilling unit;
an expression of the cooling water mass conservation related constraint relationship is shown as formula (5):
$${M}_{cw , r 0} = {\sum }_{i = 1}^{n} {M}_{c w , i} + {M}_{c w , p} \qquad Formula ( 5 )$$
where M_{cw,0} represents a cooling water flow of a cooling water main, M_{cw,i} represents a cooling water flow of a cooling water branch where the i^{th} water chilling unit is located, and M_{cw,p} represents a cooling water flow of a cooling water bypass pipe;
an expression of the cooling water energy conservation related constraint relationship is shown as formula (6):
$$( {T}_{cw , s 0} - {T}_{cw , r 0} ) \cdot {M}_{cw , 0} = {\sum }_{i = 1}^{n} ( ( {T}_{cw , si} - {T}_{cw , ri} ) \cdot {M}_{cw , i} ) - ( \overline{{T}_{cw , s}} - \overline{{T}_{cw , r}} ) {M}_{cw , p} \qquad Formula ( 6 )$$
where T_{cw,s0} represents a cooling water temperature of a cooling water supply main, T_{cw,r0} represents the cooling water temperature of the cooling water return main, T_{cw,si} represents a cooling water supply temperature of the i^{th} water chilling unit, T̅_̅{̅c̅w̅,̅s̅}̅ represents an average value of the cooling water supply temperature of all water chilling units, and T̅_̅{̅c̅w̅,̅r̅}̅ represents an average value of the cooling water return temperature of all the water chilling units.
